(19) United States
(12) Patent Application Publication
(10) Pub. No.: US 2025/0225499 A1
(43) Pub. Date: Jul. 10, 2025

(54) Break Prediction System

(71) Applicant: Toshiba Global Commerce Solutions, Inc., Durham, NC (US)

(72) Inventors: John Wendler, Raleigh, NC (US); Benjamin Duan-Porter, Eden Prairie, MN (US); Phillip Monkowski, Apex, NC (US); Sarath Surya, Raleigh, NC (US)

(21) Appl. No.: 18/403,993

(22) Filed: Jan. 4, 2024

(51) Int. Cl. G06Q 20/32; G06Q 20/20

(52) U.S. Cl. CPC G06Q 20/3224; G06Q 20/20

(57) ABSTRACT

A method, performed by a computing device, for determining a break during a live event. The method includes collecting real-time data from sensors observing a live event at an event venue. The method further includes training a prediction model using the real-time data and historical data collected from one or more past events. The event further includes predicting when the break is likely to occur during the live event using the prediction model. In addition, the method includes transmitting a notification to at least one mobile device present at the live event of the prediction.

### BACKGROUND

Artificial Intelligence (AI) is a field of computer science that enables computers to mimic cognitive functions traditionally associated with human intelligence in order to solve problems. Machine Learning (ML) is a branch of Al that enables a computer to learn from experience in order to make improved predictions. Al often employs ML as a learning mechanism, e.g., so that a computer can act upon new data without having to be explicitly programmed to do so.

Attendees of a live event often miss important parts of the event while waiting in long lines to visit restrooms or purchase items (e.g., food, drink, gifts and paraphernalia). Some live events have designated intermissions in which many people at the event venue will flood to the concession area to make purchases. Other events are more fluid and do not have designated intermissions of any significant length. In either case, attendees ultimately waste time in lines to purchase their favorite concessions, often at inopportune times.

### BRIEF DESCRIPTION OF THE DRAWINGS

Aspects of the present disclosure are illustrated by way of example and are not limited by the accompanying figures with like references indicating like elements.

FIG. 1 is a schematic of an example event venue according to some aspects of the present disclosure.

FIG. 2 shows a schematic of a mobile device display, including predicted break information, according to some aspects of the present disclosure.

FIG. 3 is a flow diagram illustrating an example method according to some aspects of the present disclosure.

FIG. 4 is a schematic block diagram illustrating an exemplary computing device according to some aspects of the present disclosure.

### DETAILED DESCRIPTION

The present disclosure generally relates to predicting future break information from past and current data related to a live event.

The system may implement Al to predict that a future break may occur during a live event so that an attendee may visit a concession area without missing significant portions of the event. The system may, for example, predict break time intervals and determine locations suitable to both the attendees' preferences and ongoing events. A notification of a predicted break time is then sent to a mobile device associated with the attendee.

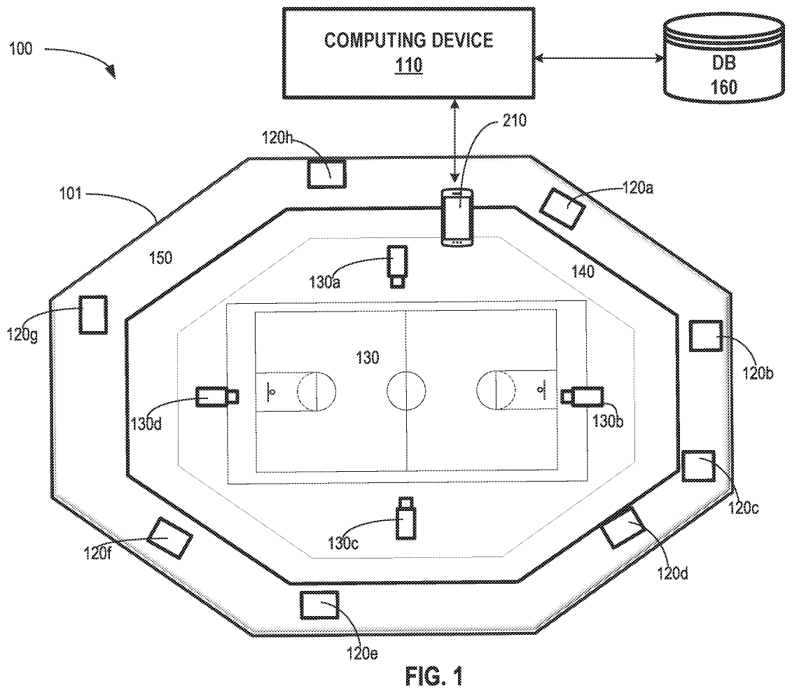

FIG. 1 is a schematic of a break prediction system 100 for predicting event information implemented in an exemplary event venue 101. The break prediction system 100 includes a computing device 110, database 160, Point of Sale (POS) terminals 120a-h and sensors 130a-d.

The event venue 101 may be an indoor or outdoor event venue. The live event may be any type of live event, including a sporting or performing arts event. The live event may include breaks which may be scheduled or unscheduled. An unscheduled break is an intermission with no definite start time. Most events have breaks that follow specific rules depending on the sport or event. For example, in professional basketball, halftime may be considered an intermission between halves of the game. However, the start of halftime may vary depending on the length of other unscheduled intermissions occurring in the first half, such as timeouts. In this case, for the purposes of this disclosure, a break with no definite start time is considered an unscheduled break time. In contrast, break times with a specific start time are scheduled break times.

In some examples, the computing device 110 may use a prediction model to determine break times including an intermission, halftime, a scheduled timeout, an unscheduled timeout, medical break times, emergency breaks, etc.

The database 160 stores historical data, including an attendee profile and past break time information from previous events.

The computing device 110 may be a centralized computing resource configured to perform break information prediction. The computing device 110 may further include computer vision logic for processing and analyzing image data and/or depth data measured from sensors 130a-d. The computer vision logic may be implemented in software, hardware, firmware, or any combination thereof. The computing device 110 may be situated within or outside of the event venue 101.

The computing device 110 may use Al (e.g., ML) to analyze data collected from multiple sources and determine break times for an attendee associated with a mobile device 210. The data may include real-time and stored historical data. The computing device 110 may identify patterns in past break times and detect current conditions in real-time data in order to predict with a higher degree of certainty future break times during an event. This is especially useful for live events with unscheduled break times such as timeouts.

To enable Al and ML the break prediction system 100 may use a statistical model to identify the patterns in stored and real-time data to generate break information. The break information may have a corresponding probability of correctness (sometimes referred to as a confidence). A traditional ML approach often involves selecting and preparing a training dataset and applying an ML strategy (e.g., linear regression) to refine the training dataset. Through iterative refinement of the dataset, often with updated data and error checking, data quality generally increases and the model improves over the course of its lifetime. With more and better data, a sound ML model will make increasingly better predictions.

According to one example, at the start of a live event, an attendee located within the event venue 101 receives one or more electronic notifications to their mobile device 210 indicating available future break times. The electronic notification may be received from a computing device 110 for determining the available break times. The computing device 110 is configured to collect stored data and data measured, in real-time, from sensors located across the event venue 101 during the live event.

One or more sensors 130a-d may be configured to observe the event. The sensors may be, for example, cameras, depth sensors or optical sensors. In some examples, the sensors 130a-d may be positioned throughout the venue. In some examples, the sensors 130a-d may be positioned such that the sensors may capture game events or scoreboards. In other examples, the cameras may be positioned such that they capture foot traffic within the event venue 101, including seating areas 140 and concessions areas 150. Items (e.g., food, drink, gifts, paraphernalia) may be purchased at the POS terminals 120a-h, each PoS terminal 102a-h being associated with a concession stand located at the event venue 101. In some examples, the sensors 130a-d may be part of, or collocated with, the POS terminals 120a-h.

Each of the sensors 130a-d and PoS terminals 120a-h serve as data sources for the computing device 110. In some examples, several other data sources may also be considered when evaluating break information. For example, the computing device may predict break information based on the attendee sharing historical data with the system. The historical data may include prior purchase information, including the date, time and location at the event venue 101. The historical data may additionally or alternatively include prior purchases, including date and time from other venues for the same live event. Additionally or alternatively, the historical data may include personal preferences for food and drinks for any live event and information about the other ticket holders that accompanied the attendee to this live event (e.g., family, friends, coworkers, etc.).

The computing device 110 may generate personalized break times and locations preferred by an attendee associated with a mobile device 210. Generating personalized break times may be accomplished by filtering time slots and break time locations according to an attendee profile associated with the mobile device 210. Filtering the time slots allows the computing device to present the attendee with break times that are more likely to be taken by the attendee. For example, the historical data may indicate that the attendee is more likely to spend a break time purchasing food items at the beginning of the event. In this case, the computing device 110 will provide both food, concession stand locations, and break times at the beginning of the live event. In some examples, the mobile device 210 associated with this particular attendee profile may not receive information about PoS terminals 120a-h selling non-food items or about break times during the middle or end of the live event.

The computing device 110 collects transaction time data from PoS terminals 120a-h to determine a personalized break time for an attendee associated with a mobile device 210. The transaction times may indicate the overall wait time for purchasing an item.

Once a break time is established a proposed break location may be refined based on the wait times at each of the PoS terminals 120-a-h. The computing device 110 may collect real-time data including tracked transactions from a plurality of PoS terminals 120a-h and determine wait times associated with the plurality of PoS terminals 120a-h based on the tracked transactions. This way the computing device 110 may select a PoS terminal 120a-h with the least wait time during the predicted break. For example, according to the attendee profile there may be multiple PoS terminals 120a-h that sell the attendee's preferred items. To avoid unnecessary waiting times, the computing device 110 may select the PoS terminal 120a-h with the least activity so that the attendee does not waste time in line.

In some examples, real-time foot traffic patterns are analyzed using computer vision techniques to determine whether a certain PoS terminal 120a-h is congested or to detect the crowds within the event venue 101 or the lack thereof.

The computing device 110 may be configured to train a prediction model to avoid selecting and notifying the mobile device 210 of break times and locations within the event venue with high traffic and instead select break times and locations with relatively less traffic. Training the prediction model includes identifying the amount of foot traffic within an area from the collected real-time and historical data. The concessions area 150 and seating area 140 may be observed using sensors 130a-d, and the real-time foot traffic may be identified using computer vision techniques. The historical data may be received from the database 160. Responsive to determining whether the amount of foot traffic is over a threshold amount, the computing device 110 is configured to filter (e.g., deselect) a time slot and location associated with the area. The computing device 110 may predict time slots and locations with less than a threshold amount of traffic. The threshold amount of traffic may be predetermined based on the attendee capacity or size of identified traffic crowds observed throughout the event venue 101 by the sensor 130a-d at the current time.

In some examples, when a live event is a sporting event, the computing device 110 may also analyze real-time game statistics to predict possible lulls or highs in activity.

Advantageously, the computing device 110 may predict break times during sporting events that are unlikely to occur at crucial moments. A crucial moment is considered a period during the sporting event that an attendee may not want to miss. For example, a crucial moment in a sporting event may occur when a game's score is tied and the current game time is almost over. Historically, unscheduled timeouts are most likely to be called by a team at the end of a tied game. In this case, to predict a break time that avoids crucial moments in sporting events, the computing device 110 may be configured to predict, using the prediction model, when the break is likely to occur based on a current game score and a current game time. The mobile device 210 may be notified of the predicted break time. However, the notification may also include that the break time is predicted based on the identified crucial moment.

The computing device 110 may be suitable for determining and transmitting break information for many attendees at event venues with a sizable seating or attendance capacity, including but not limited to stadiums and arenas. The computing device 110 may simultaneously predict and coordinate break times for mobile devices 210 located within an event venue 101. The computing device 110 may coordinate break times for the mobile devices 210 within the event venue 101 to prevent giving numerous attendees the same break information.

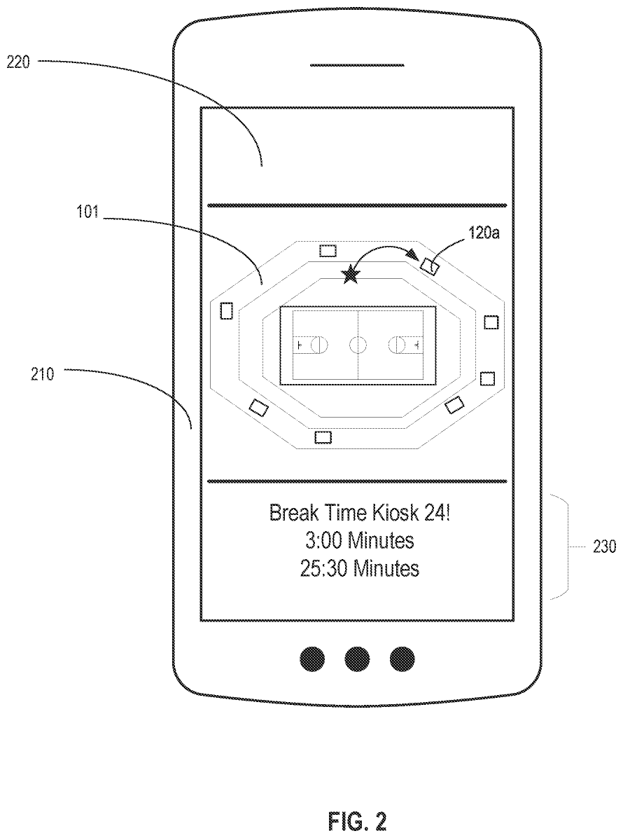

FIG. 2 shows a schematic of a mobile device 210, including predicted break information 230, according to some aspects of the present disclosure. When a break is predicted for an attendee associated with a mobile device 210, a notification is sent to the mobile device 210. The mobile device 210 may generate a graphical notification interface showing the event venue 101 and the location of the mobile device 210 within the event venue 101. The predicted break information 230 may also be displayed and may include the predicted break time and a location predicted to be available during the break. The predicted break times may include one or more predicted times before the end of the live event. As an example, FIG. 2 shows a predicted break time occurring in 3:00 minutes and another predicted break time occurring in 25:30 minutes. In addition to the predicted break times, a PoS terminal 120a location with little or no transaction activity may be depicted in the graphical notification. The location of the mobile device 210 relative to the POS terminal 120a location may also be depicted as well as directions to the POS terminal 120a (not shown).

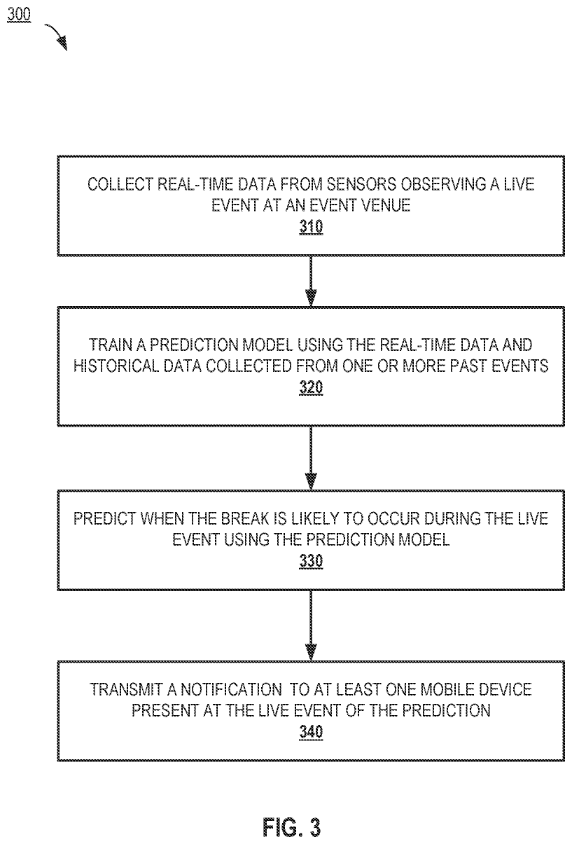

FIG. 3 is a flow chart illustrating an example method 300 for determining a break during a live event. The method 300 is implemented by a computing device 110. The method 300 includes collecting real-time data from sensors 130a-d observing a live event at an event venue 101 (block 310). The method 300 further includes training a prediction model using the real-time data and historical data collected from one or more past events (block 320). The method 300 further includes predicting when the break is likely to occur during the live event using the prediction model (block 330). In addition, the method includes transmitting a notification to at least one mobile device 210 present at the live event of the prediction (block 340).

According to some embodiments, training a prediction model using the real-time data and historical data collected from one or more past events 320 includes identifying an amount of foot traffic within an area from the collected real-time data and historical data. Training the prediction model may additionally or alternatively include, responsive to determining whether the amount of foot traffic is over a threshold amount, filtering a time slot and location associated with the area to predict time slots and locations with less than a threshold amount of traffic.

According to some embodiments, predicting when the break is likely to occur during the live event using the prediction model 330 further includes predicting when an unscheduled intermission of the live event is likely to occur. In some examples, predicting the timing of the unscheduled intermission may be performed using foot traffic data or historical data from similar previous events.

According to some embodiments, predicting when the break is likely to occur during the live event using the prediction model 330 includes filtering time slots and break time locations, according to an attendee profile, to predict time slots and locations preferred by an attendee associated with the mobile device. The attendee profile data may be stored on the computing device 110 or database 160 along with the profiles of other attendees.

According to some embodiments, predicting when the break is likely to occur during the live event using the prediction model 330 includes predicting when the break is likely to occur based on a current game score and a current game time. In some examples, the current game score and game time may be determined using computer vision. Alternatively, or additionally, the same time and score may be received at the computing device.

According to some embodiments transmitting a notification at least one mobile device present at the live event of the prediction 340 includes notifying a PoS terminal 120a-h that an attendee associated with the mobile device is likely to perform a transaction at the PoS terminal 120a-h.

According to some embodiments the mobile device is associated with an attendee of the live event.

According to some embodiments the method for determining break information during a live event further includes collecting real-time data including tracked transactions from a plurality of point of sale (POS) terminals. The method also includes determining the wait times associated with the plurality of POS terminals 120a-h based on the tracked transactions. In addition, the method includes predicting that a PoS terminal 120a-h will have the least wait time during the predicted break.

Other embodiments include a computing device including processing circuitry and memory including instructions executable by the processing circuitry whereby the processing circuitry is configured to perform the steps of method 300.

Other embodiments include a non-transitory computer-readable medium storing a computer program including software instructions that, when run on processing circuitry of a break prediction system, cause the break prediction system to perform the steps of method 300.

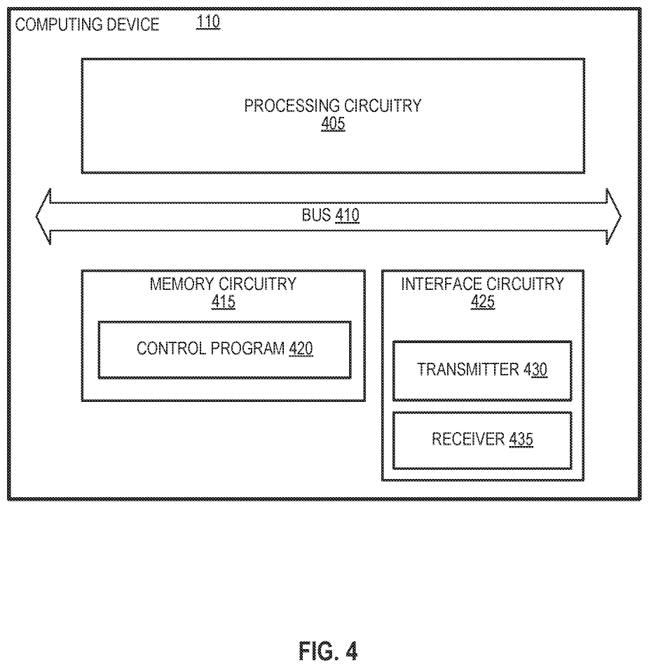

FIG. 4 is a schematic block diagram illustrating an exemplary computing device 110. The computing device 110 includes processing circuitry 405, memory circuitry 415, and interface circuitry 425. The processing circuitry 405 is communicatively coupled to the memory circuitry 415 and the interface circuitry 435, e.g., via one or more buses 410. The processing circuitry 405 may include one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, processing circuitry 405 may be programmable hardware capable of executing a control program 420 stored, e.g., as a machine-readable computer program 420 in the memory circuitry 415. The memory circuitry 415 of the various embodiments may include any non-transitory machine-readable media known in the art, or that may be developed, whether volatile or non-volatile, including but not limited to solid state media (e.g., SRAM, DRAM, DDRAM, ROM, PROM, EPROM, flash memory, solid-state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in any combination.

The interface circuitry 425 may be a controller hub configured to control the input and output (I/O) data paths of the computing device 110. Such I/O data paths may include data paths for exchanging signals over a communications network and data paths for exchanging signals with an electronic device or a user. For example, interface circuitry 425 may include a transceiver 430 configured to send and receive communication signals over one or more of a cellular network, Ethernet network, or optical network. The interface circuitry 425 may also include (or be communicatively connected to) one or more a graphics adapter, display port, video bus, touchscreen, graphical processing unit (GPU), display port, Liquid Crystal Display (LCD), and Light Emitting Diode (LED) display, for presenting visual information to a user. The interface circuitry 425 may also include one or more of a pointing device (e.g., a mouse, stylus, touchpad, trackball, pointing stick, joystick), touchscreen, microphone for speech input, optical sensor for optical recognition of gestures, and keyboard for text entry. In some aspects of the current disclosure, the computing device 110 may additionally or alternatively include a combination of sensors 130a-d, including one or more cameras, device sensors, scanners, and one or more displays, audio devices (i.e., speakers), I/O devices, scanners, device sensors, illumination sources, and/or near-field receivers, either as part of the interface circuitry 425 or communicatively connected to it.

The interface circuitry 425 may be implemented as a unitary physical component or as a plurality of physical components that are contiguously or separately arranged, any of which may be communicatively coupled to any other or may communicate with any other via the processing circuitry 405. For example, the interface circuitry 425 may include output circuitry (e.g., transmitter circuitry 430 configured to send communication signals over the communications network) and input circuitry (e.g., receiver circuitry 435 configured to receive communication signals over the communications network and or a device sensor network). Similarly, the output circuitry may include a display, whereas the input circuitry may include a keyboard, touch screen, or card reader. Other examples, permutations, and arrangements of the above and their equivalents will be readily apparent to those of ordinary skill.

The present disclosure may, of course, be carried out in other ways than those set forth herein without departing from essential characteristics of the present disclosure. The present embodiments are to be considered in all respects as illustrative and not restrictive, and all changes coming within the meaning and equivalency range of the appended claims are intended to be embraced therein. Although steps of various processes or methods described herein may be shown and described as being in a sequence or temporal order, the steps of any such processes or methods are not limited to being carried out in any particular sequence or order, absent an indication otherwise. Indeed, the steps in such processes or methods generally may be carried out in various sequences and orders while still falling within the scope of the present disclosure.

While the concepts of the present disclosure are susceptible to various modifications and alternative forms, specific exemplary aspects of the disclosure have been shown by way of example in the drawings and are described in detail herein. It should be understood, however, that there is no intent to limit the concepts of the present disclosure to the particular forms disclosed, but on the contrary, the intention is to cover all modifications, equivalents, and alternatives consistent with the present disclosure and the appended claims.

1. A method comprising:
collecting real-time data from sensors observing a live event at an event venue;
training a prediction model using the real-time data and historical data collected from one or more past events;
predicting when the break is likely to occur during the live event using the prediction model; and
transmitting a notification to at least one mobile device present at the live event of the prediction.

2. The method of claim 1, further comprising predicting when an unscheduled intermission of the live event is likely to occur.

3. The method of claim 1, wherein predicting when a break is likely to occur further comprises filtering time slots and break time locations, according to an attendee profile, to predict time slots and locations preferred by an attendee associated with the mobile device.

4. The method of claim 1, further comprising collecting real-time data including tracked transactions from a plurality of point of sale (POS) terminals; determining the wait times associated with the plurality of PoS terminals based on the tracked transactions; and predicting that a PoS terminal will have the least wait time during the predicted break.

5. The method of claim 1, wherein training the prediction model includes identifying an amount of foot traffic within an area from the collected real-time data and historical data; and responsive to determining whether the amount of foot traffic is over a threshold amount, filtering a time slot and location associated with the area to predict time slots and locations with less than a threshold amount of traffic.

6. The method of claim 1, wherein predicting when the break is likely to occur is based on a current game score and a current game time.

7. The method of claim 1, further comprising notifying a PoS terminal that an attendee associated with the mobile device is likely to perform a transaction at the PoS terminal.

8. The method of claim 1, wherein the mobile device is associated with an attendee of the live event.

9. A computing device comprising:
processing circuitry and memory comprising instructions executable by the processing circuitry whereby the processing circuitry is configured to:
collect real-time data from sensors observing a live event at an event venue;
train a prediction model using the real-time data and historical data collected from one or more past events;
predict when the break is likely to occur during the live event using the prediction model; and
transmit a notification to at least one mobile device present at the live event of the prediction.

10. The computing device of claim 9, further configured to predict when an unscheduled intermission of the live event is likely to occur.

11. The computing device of claim 9, wherein to predict when a break is likely to occur the computing device is further configured to filter time slots and break time locations, according to an attendee profile, to predict time slots and locations preferred by an attendee associated with the mobile device.

12. The computing device of claim 9, wherein the computing device is further configured to collect real-time data including tracked transactions from a plurality of point of sale (PoS) terminals; determine the wait times associated with the plurality of PoS terminals based on the tracked transactions; and predict that a PoS terminal will have the least wait time during the predicted break.

13. The computing device of claim 9, wherein to train the prediction model the computing device is configured to identify an amount of foot traffic within an area from the collected real-time data and historical data; and responsive to determining whether the amount of foot traffic is over a threshold amount, filter a time slot and location associated with the area to predict time slots and locations with less than a threshold amount of traffic.

14. The computing device of claim 9, wherein predicting when the break is likely to occur is based on a current game score and a current game time.

15. The computing device of claim 9, wherein the computing device is further configured to notify a PoS terminal that an attendee associated with the mobile device is likely to perform a transaction at the PoS terminal.

16. The computing device of claim 9, wherein the mobile device is associated with an attendee of the live event.

17. A non-transitory computer-readable medium storing a computer program comprising software instructions that, when run on processing circuitry of a break prediction system, cause the break prediction system to:
collect real-time data from sensors observing a live event at an event venue;
train a prediction model using the real-time data and historical data collected from one or more past events;
predict when the break is likely to occur during the live event using the prediction model; and
transmit a notification to at least one mobile device present at the live event of the prediction.
